(19) United States
(12) Patent Application Publication
(10) Pub. No.: US 2019/0232432 A1
(43) Pub. Date: Aug. 1, 2019

(54) METHOD FOR LASER-BASED GENERATION OF A STRUCTURE ON A RAKE FACE OF A CUTTING TOOL

(71) Applicant: ACSYS Lasertechnik GmbH, 70806 Kornwestheim (DE)

(72) Inventors: CHRISTIAN KREISEL, MITTWEIDA (DE); MARCUS POLSTER, LUDWIGSBURG (DE); GERHARD KIMMEL, KORNWESTHElM (DE)

(73) Assignee: ACSYS Lasertechnik GmbH, 70806 Kornwestheim (DE)

(21) Appl. No.: 16/262,025

(22) Filed: Jan. 30, 2019

(30) Foreign Application Priority Data
Jan. 31, 2018 (DE) 10 2018 102 108.9

(51) Int. Cl. B23K 26/38; B23C 5/02

(52) U.S. Cl. CPC B23K 26/38; B23K 2101/20; B23C 5/02

(57) ABSTRACT

A method for the laser-based generation of a structure on a rake face of a cutting tool is disclosed, where at least one structure is formed by lines that are generated with a mutual spacing of at most 400 μm with a laser beam at least in areas within a predetermined contour on at least one rake face of the cutting tool. A course of the lines forming the structure is oriented with respect to a profile of at least one cutting edge of the at least one rake face.

### CROSS-REFERENCES TO RELATED APPLICATIONS

This application claims the priority of German Patent Application Serial No. 10 2018 102 108.9, filed Jan. 31, 2018, pursuant to 35 U.S.C. 119(a)-(d), the subject matter of which is incorporated herein by reference.

### BACKGROUND OF THE INVENTION

The invention relates to a method for laser-based generation of a structure on a rake face of a cutting tool.

During machining of materials, the employed cutting materials are exposed to high loads, which are mainly caused by temperature fluctuations, abrupt cutting forces and high feed rates. A so-called built-up edge may be formed as a result of temperature fluctuations and unfavorable chip formation on rake faces or open spaces, whereby material accumulates on the cutting edge which adversely affects the geometry of the cutting wedge. The changes at the cutting wedge reduce the cutting force at constant feed rates, which can lead to vibrations that adversely affect the surface quality of the machined material, which is particularly relevant for turned parts and milled parts. Another problem is that the built-up edge can break, causing material to be entrained by the cutting material, so that the cutting material must be changed early on. Known measures for avoiding formation of a built-up edge include, in addition to increasing the cutting speed and employing coated cutting materials, adapting the chip-deflecting macro-geometry on the cutting edge, which can affect the chip formation behavior.

It is also known that the frictional force and the frictional heat can be reduced by employing micro-textures or microstructures on tool surfaces, which also advantageously prevents formation of built-up edges. Such microstructures are usually produced by using laser radiation, wherein small amounts of material are vaporized with a focused laser beam commensurate with a predetermined contour, leaving a desired structure. With conventional methods, auxiliary structures are usually employed in the laser-based generation of a specific structure or a specific contour at a desired position, wherein the structure to be generated or the contour to be generated is typically oriented with respect to the auxiliary structures. Disadvantageously, however, generating the auxiliary structures requires an additional process step, which is accompanied by an increased expenditure of time for generating the structure. Even a mere projection of auxiliary structures requires an additional process step, since the tool or the area to be structured and the auxiliary structures must be positioned relative to one another. In particular, when generating microstructures on regrindable tools, where the dimensions of the cutting edges and the rake faces can change during regrinding, positioning of auxiliary structures requires more time and is hence associated with higher costs.

Nothing in the following discussion of the state of the art is to be construed as an admission of prior art.

It would therefore be desirable and advantageous to provide an improved method to generate the structure of a rake face and to obviate prior art shortcomings.

### SUMMARY OF THE INVENTION

It is therefore an object of the invention to propose a method which is suitable for generating a laser-based structure on a rake face of a cutting tool in a simple manner and in less time.

The object is attained by a method having the features of claim 1. Advantageous embodiments are recited in the dependent claims.

According to the invention, a method for laser-based generation of a structure on a rake face of a cutting tool is proposed wherein at least one structure is formed by lines, wherein the lines, which may have a line width of 5 μm to 100 μm and a mutual spacing of at most 400 μm, are generated with a laser beam at least in areas within a predetermined contour on at least one rake face of the cutting tool, wherein an alignment or a course of the structure-forming lines is oriented with respect to a profile of at least one cutting edge of the at least one rake face.

Modulated and pulsed solid-state lasers with a pulse duration of less than 1 ms can be used to generate the lines forming the structure. The use of gas lasers is also conceivable. The size of the focal point of the employed laser radiation may vary between 5 μm and 100 μm. No restrictions exist with regard to the wavelengths of the employed lasers. The wavelengths are usually in the near infrared region (NIR), in the region of UV radiation or in the visible region of the light. Furthermore, the lines forming the structure may be generated under a protective gas atmosphere.

An orientation of the course of the lines with respect to the profile of the cutting edge is to be understood such that the line pattern of the lines forming the structure is modeled after the course of the profile of the cutting edge. In the case of linear cutting edges, the structure can therefore be formed with essentially parallel lines. A line may hereby be aligned so as to match the orientation of the preceding line. With an alignment of the lines forming the structure commensurate with the profile of the cutting edge, the position of the lines within the contour relates to the profile of the respective at least one cutting edge.

The method according to the invention has the advantage that the structure or the lines forming the structure are oriented with respect to the profile of a cutting edge of a rake face of the cutting tool, so that a microstructure can be produced on the rake face without requiring additionally generating or designing auxiliary structures. This is particularly advantageous when producing structures on regrinding tools such as drills or hard metal cutters, since the structure of the rake face is then commensurate in each case with the profile of the individual cutting edge, thereby obviating the need for complex positioning of auxiliary structures with respect to the changed (reground) tool cutting edge. Advantageously, a rake face can hereby be structured to match the individual profile of the cutting edge.

The contour delimits on the at least one rake face an area which is to be structured by the laser beam. In this case, the contour in the context of the invention is at least partially oriented with respect to the course of the profile of the cutting edge of the cutting tool. The structure is formed within the contour, wherein the lines forming the structure may preferably run parallel, wherein the lines may have a wavy course or a zig-zag course. At the same time, the lines may follow the course of the profile of the cutting edge of the cutting tool or may be aligned with the profile of the cutting edge.

A structure can be generated in each case with a predetermined number of lines within a predetermined contour, wherein several structures may also be generated on a rake face. Various structural shapes, such as, for example, a wedge structure or a zig-zag structure, may be generated by combining the lines of the original structure with the lines of the additional structures. If the intent is generate several structures, the structures may in the case of, for example, three structures be referred to as the first structure, the second structure, and the third structure, with each structure being generated within its assigned contour. Similarly, according to the above example, the contours may be referred to as the first contour, the second contour and the third contour. Furthermore, contours may be arranged with mutual overlap, so that the structures formed within the overlapping contours then also overlap, allowing the formation of different structural shapes. The additional structures or contours can each be oriented with respect to the first structure, which is oriented with its lines with respect to the profile of the cutting edge.

According to one embodiment variant of the method according to the invention, a known profile of a cutting edge of a cutting tool may be used as a reference profile in order to structure a rake surface of several identical tools based on the reference profile. This is advantageous if a series of identical tools is to be structured, wherein the rake surfaces to be structured each have identical cutting edges, so that no further adjustments in the position of the structure to be generated are required. In order to produce structures on a rake face having a varying cutting edge profile, which may be the case with cutting tools having more than one cutting edge or with regrinding tools, the profile of the at least one cutting edge may preferably be measured optically (scanned). For example, the profile of the cutting edge may be measured based a shadow cast by the relevant edge of the cutting edge. Measuring the profile of the at least one cutting edge may be executed as an additional method step of the method according to the invention. Preferably, the method step of measuring the profile of the at least one cutting edge may be carried out before generating a structure on the rake face.

The rake face is to be understood as the area of the cutting tool over which a chip is removed during machining of a material. A rake face may therefore contact a major cutting edge and a minor cutting edge of a drill, a milling cutter or chisel. Especially with rotating cutting tools, such as drills or milling cutters, a rake surface may have a curvature, so that chips are removed in a desired direction. Preferably, the curvature of a rake face is taken into account in the generation of the structure by adapting the focal point of the laser beam to the curvature of the rake face. In this way, a uniform structure with uniform line width and uniform line depth (structure depth) can be generated on the curved rake face. Advantageously, a profile or a curvature of the at least one rake face may preferably be measured optically. Determining the profile of the at least one rake face may be provided as an additional method step.

Additionally, a shape or an orientation of the lines forming the structure may be generated depending on the profile of the cutting edge and/or depending on the profile of the curvature of the rake face. Thus, for example, an alignment of the lines may be selected, which favors a chip removal in a certain direction.

According to one embodiment variant of the method according to the invention, the lines forming the structure are produced at a predetermined distance in the range of 10 μm to 500 μm from the at least one cutting edge. Furthermore, the lines forming the structure may be produced with a variable mutual spacing.

According to another advantageous embodiment of the method according to the invention, the lines forming the structure may be oriented at a predetermined angle about a predetermined pivot point. Preferably, the lines forming the structure may be aligned at an angle of 0°, 90° or 135° with respect to the cutting edge. By virtue of the orientation with a predetermined angle, advantageous structures can be provided which promote chip breakage and chip removal, for example in a desired direction. Furthermore, lines may be generated which are oriented with respect to the profile of the cutting edge and have a random angular orientation. A random angular orientation can be generated in the following manner first, a preferred angle with respect to the cutting edge and a maximum angle variance is defined. Thereafter, all lines are aligned with respect to the preferred angle. Using software, the maximum angular variance for each line is then multiplied by a random number (floating-point number) between 1 and −1. This results in a corresponding angle for each line.

Furthermore, the lines may be generated discontinuously, wherein the breaks have a predetermined length. Further structuring features can be achieved by generating the breaks between at least two lines with a predetermined offset. According to a further embodiment of the structure, the lines may have a wavy shape.

It has been found that, in particular with structural depths in the range from 5 μm to 50 μm, advantageous effects with respect to improved chip removal and improved wear resistance are achieved. Accordingly, the lines forming the structure may be generated with a depth in a range between 5 μm to 50 μm.

According to an advantageous simple embodiment of the method according to the invention, the contour may be delimited on the rake face by a main cutting edge and/or by a secondary cutting edge of the cutting tool. As a result, no further positioning of the contour is then required since in this embodiment variant, the lines forming the structure are produced over the entire rake face.

According to another embodiment of the method according to the invention, the starting points of the lines forming the structure are oriented with respect to the profile of the at least one cutting edge. In this case, the lines forming the structure are generated so as to each start at the same distance from the edge of the cutting edge. This variant is particularly suitable for structures whose lines are oriented at an angle or perpendicular to the respective cutting edge.

As already described above, at least one additional structure may be formed by way of lines on the at least one rake face within another contour, wherein the lines are formed with a laser beam and have a line width of at most 100 μm and a mutual spacing of at most 400 μm, wherein an orientation or a course of the lines forming the additional structure is oriented with respect to the contour of the already existing structure or with respect to the orientation of the lines of the already existing structure. Furthermore, according to this embodiment, the lines forming the additional structure may be produced with an orientation so that the lines of the first structure and the lines of the additional structure form a wedge shape.

It has been found that, with the method according to the invention, rake faces of cutting tools can be structured in a simple manner and in a shorter time by using laser radiation. Furthermore, it has been shown that because the cutting edge is structured with an orientation commensurate with the profile of the rake face, both chip removal and wear resistance can be improved.

### BRIEF DESCRIPTION OF THE DRAWING

Further details, features and advantages of embodiments of the invention will become apparent from the following description of exemplary embodiments illustrated in the drawings, which show in:

FIG. 1: a schematic diagram for explaining the method according to the invention;

FIG. 2: a diagram of a drilling tool with a structure generated on a rake face in accordance with method according to the invention;

FIG. 3: a diagram of a drilling tool with another structure generated on a rake face in accordance with method according to the invention; and

FIG. 4: an overview of rake faces with different structures produced with the method according to the invention as well as respective shapes of chips obtained during material processing.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

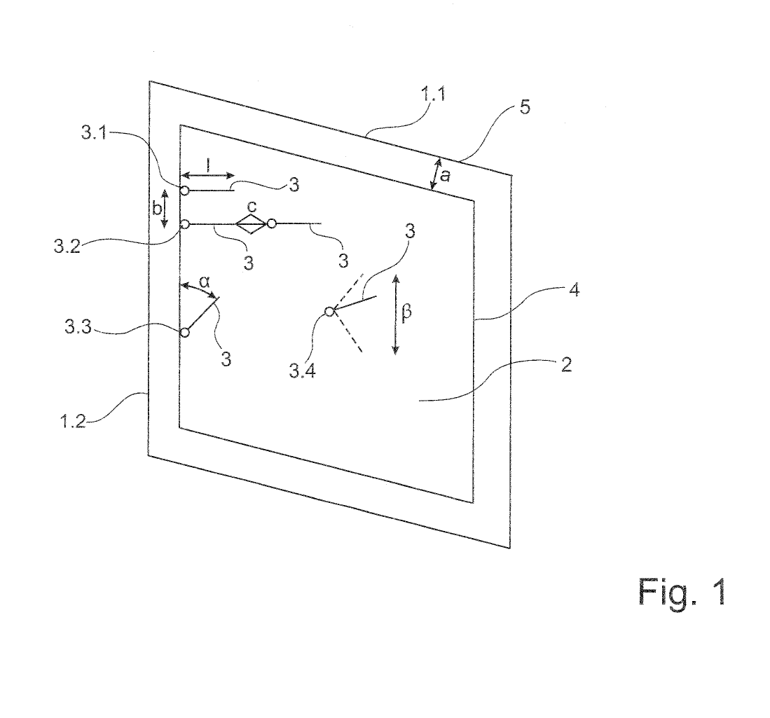

FIG. 1 shows a schematic diagram describing the method according to the invention for the laser-based generation of a structure on a rake face 2 of a cutting tool. With the method according to the invention, a structure with lines 3 is formed, wherein the lines 3 with a maximum mutual spacing of 100 μm are generated with a laser beam at least in areas within a predetermined contour 4 on the rake face 2, wherein an orientation or a course of the lines 3 forming the structure is oriented with respect to the profile of a cutting edge, which in the illustrated example has a main cutting edge 1.1 and a secondary cutting edge 1.2. In the illustrated example, the contour 4 is modeled after the profile of the cutting edges 1.1, 1.2. The reference numerals 3.1 to 3.4 refer to variants of orientations of the lines 3 forming the structure. A structure is here formed in each case by a plurality of lines 3 having one of the illustrated orientation variants. The starting points (enlarged points) of the lines 3 of the orientation variants 3.1, 3.2 and 3.3 to be generated by the laser beam are each oriented with respect to the profile of the secondary cutting edge 1.2. In the orientation variant 3.1, a line length is marked with the variable I. The variable b indicates the distance between two lines, which according to the invention is at most 100 μm. The orientation variant 3.2 is a structure in which the lines 3 are formed with a discontinuity or break c. The length of a break c is variable. The orientation variant 3.3 is characterized by a predetermined angle α about which the lines 3 are oriented on the profile of the cutting edge. In the orientation variant 3.4, the lines 3 are each oriented in a random orientation at a random angle β with a random distance from the secondary cutting edge 1.2. The reference numeral 5 indicates a vertical distance of the contour 4 from the main cutting edge 1.1.

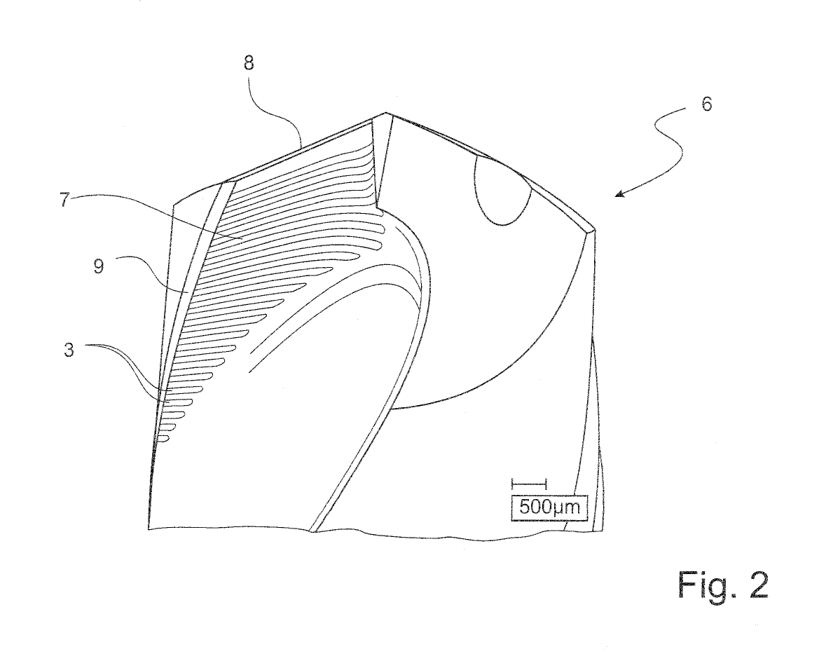

FIG. 2 shows a diagram of a drilling tool 6 with a structure produced on a rake face 7 by the method according to the invention. The structure is formed with substantially parallel lines having a spacing of 100 μm. The lines are oriented parallel to the profile of the cutting edge 8, wherein the first line is formed at a distance of 200 μm from the cutting edge 8. The structure depth, i.e. the depth of the lines in the rake face 7, is 20 μm. The contour of the structure extends over the entire rake face and is delimited by the secondary cutting edge 9.

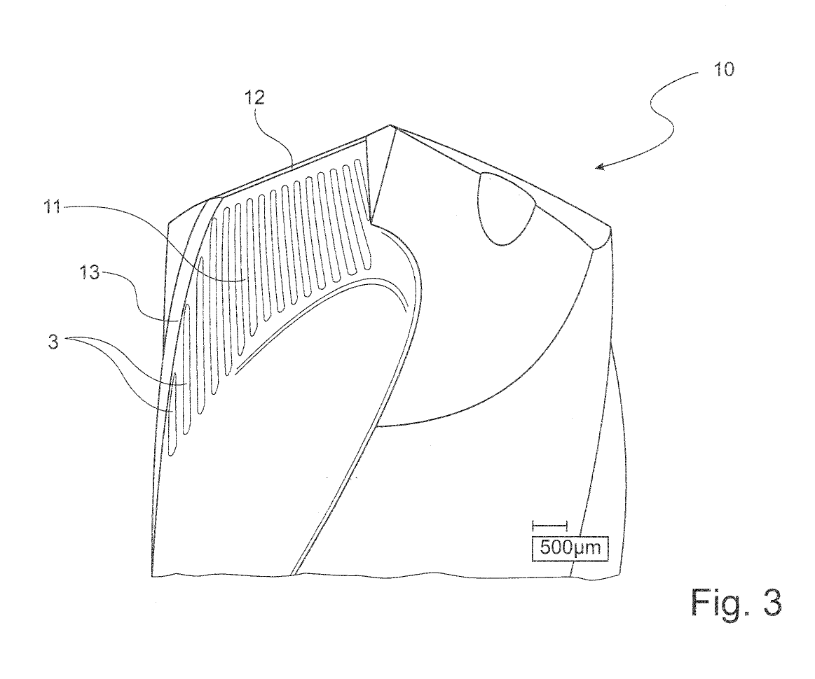

FIG. 3 shows a diagram of a further drilling tool 10 with a further structure produced on a rake face 11 by the method according to the invention with essentially mutually parallel lines oriented perpendicular to the profile of the cutting edge 12. The distance of the starting points of the lines from the cutting edge 12 is 200 μm. The distance between the lines is 100 μm. The line depth is 20 μm. The contour of the structure extends over the rake surface 11 and is delimited by the secondary cutting edge 13.

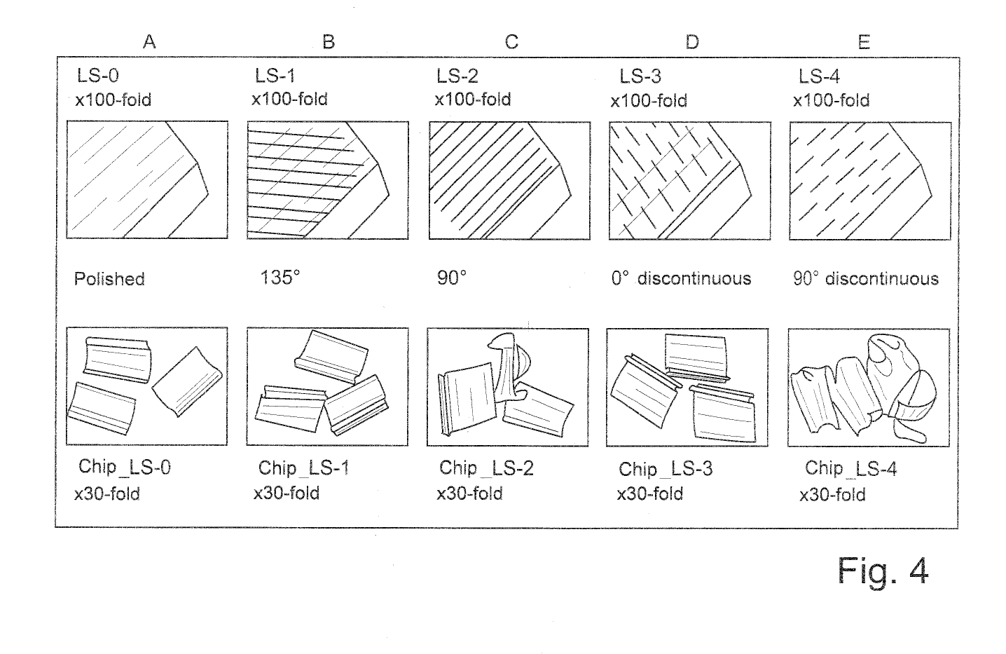

FIG. 4 shows an overview of rake faces with different structures produced by the method according to the invention, as well as respective shapes of chips obtained during machining. The rake faces shown in A to E of the first row of the overview at a 100-fold magnification are rake faces of a milling tool for polyamide milling applications. A polished chip surface without any structure is shown in column A. Column B shows a rake surface with a structure in the form of continuous lines, which are oriented at an angle of 135° with respect to the cutting edge. Column C also shows a structure with continuous lines, wherein the lines are oriented perpendicularly (90°) to the cutting edge. The illustration in column D shows a structure with discontinuous lines, wherein the breaks between the lines having a uniform offset. The lines are oriented parallel with respect to the profile of the cutting edge. Column E shows a rake surface having a structure formed with discontinuous lines, like the one shown in column D, wherein the lines are oriented perpendicular to the cutting edge.

It has been found that the cutting forces on the cutting edge can be reduced by up to 25%, the burr formation can be reduced by 25%, and the built-up edge can be reduced when machining metals with cutting tools having a structure on their rake face produced by the method according to the invention. In addition, a reduction in spalling or chipping on the tool has been observed.

The chip length can be reduced by up to 60% when machining plastic materials with cutting tools having a structure on their rake face produced by the method according to the invention, which favors the formation of short chips. Advantageously, short chips can be removed more easily by suction. Due to the favorable chip breaking behavior on the produced structures, an undesirable formation of malleable chips or spiral chips is avoided.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for the laser-based generation of a structure on at least one rake face of a cutting tool, comprising:
defining a contour on at least one rake face of the cutting tool; and
generating with a laser beam at least in areas within the defined contour at least one structure composed of lines;
wherein the lines forming the at least one structure are oriented with respect to a profile of at least one cutting edge of the at least one rake face.

2. The method of claim 1, wherein the lines have a mutual spacing of at most 400 μm.

3. The method of claim 1, further comprising measuring the profile of the at least one cutting edge optically.

4. The method of claim 1, further comprising measuring a profile of a curvature of the at least one rake face, and considering the curvature when generating the lines.

5. The method of claim 1, further comprising generating the lines with a predetermined distance from the at least one cutting edge.

6. The method of claim 1, further comprising orienting the lines forming the at least one structure with a predetermined angle α about a predetermined pivot point.

7. The method according of claim 1, wherein the lines are discontinuous and comprise breaks having a predetermined length.

8. The method of claim 7, wherein the breaks between at least two lines are generated with a predetermined offset.

9. The method of claim 1, wherein the lines have a wavy shape.

10. The method of claim 1, wherein the lines have a depth of between 5 μm and 50 μm.

11. The method of claim 1, wherein the at least one cutting edge comprises a main cutting edge or a secondary cutting edge, or both, and the contour is delimited by the main cutting edge or the secondary cutting edge.

12. The method of claim 1, wherein starting points of the lines forming the at least one structure are oriented commensurate with the course of the profile of the at least one cutting edge.

13. The method of claim 1, further comprising generating with the laser beam on the at least one rake face within a further contour at least one further structure composed of lines, and orienting the lines forming the further structure with respect to the contour of the existing structure or the orientation of the lines of an existing structure.

14. The method of claim 13, wherein the lines of the at least one further structure have a maximum linewidth of 100 μm and a maximum mutual spacing of 400 μm.

15. The method according to claim 13, wherein the lines forming the at least one further structure are oriented such that the lines of the existing structure and the lines of the at least one further structure define a wedge shape.
